(19) United States
(12) Patent Application Publication
(10) Pub. No.: US 2011/0216047 A1
(43) Pub. Date: Sep. 8, 2011

(54) PROJECTOR AND METHOD FOR PROJECTING AN IMAGE BY USING THE PROJECTOR

(75) Inventor: Takashi OZAWA, Shiojiri-shi (JP)

(73) Assignee: SEIKO EPSON CORPORATION, Tokyo (JP)

(21) Appl. No.: 13/033,044

(22) Filed: Feb. 23, 2011

(30) Foreign Application Priority Data
Mar. 5, 2010 (JP) 2010-048858

(51) Int. Cl. G09G 5/00

(52) U.S. Cl. 345/204

(57) ABSTRACT

In a projector, if an image signal other than the currently selected image signal is input, the image signal is switched to the other image signal according to the position of a shutter.

The entire disclosure of Japanese Patent Application No. 2010-048858, filed Mar. 5, 2010 is expressly incorporated by reference herein.

### BACKGROUND

1. Technical Field

The present invention relates to a projector and a method for projecting an image, the projector and the method which project an image according to input image data.

2. Related Art

In general, a projector often has a plurality of input terminals. For example, as described in JP-A-2003-323168, when the user switches the currently selected input terminal to another input terminal by performing remote control operation or the like, the projected image is switched to an image according to the image data input from the newly selected input terminal by this input switching operation.

Moreover, the function of temporarily bringing the projection of an image to a mute state to prepare the next image during a presentation is used. In the mute state, in addition to a method for projecting a black image, as described in JP-A-2007-240551, a method for blocking the light by placing a sliding shutter in front of a projection lens of the projector is used.

However, in the existing projector, even in the mute state in which the projection of the image is temporarily stopped, when some operation is performed, the mute state is immediately ended and the projection of the image is resumed. This makes it impossible to perform remote control operation in the mute state. As a result, when input terminal switching operation etc. is performed during a presentation or the like, the viewer sometimes views the screen during the operation.

Moreover, in the existing projector, projection is not performed in a light blocking state in which the shutter is closed, input terminal switching operation cannot be performed unless the shutter is opened to bring the state to a projection state.

### SUMMARY

An advantage of some aspects of the invention is to solve at least part of the problems described above, and the invention can be embodied as embodiments or application examples described below.

A projector according to an application example includes: a selecting section selecting any one of a plurality of image signals input to the projector; a projecting section projecting an image according to the image signal selected by the selecting section; a shutter blocking a projection light from the projecting section; and a position detecting section detecting the position of the shutter, and, if an image signal other than the image signal selected by the selecting section is input, the selecting section selects the other image signal according to the position of the shutter detected by the position detecting section.

According to this application example, switching operation to switch the image signal to the next image signal is performed if a state is brought to a light blocking state by closing the shutter during a presentation. Thus, if the shutter is opened again, the state enters a state in which an image of the next image signal is projected. That is, the image signal switching operation is performed in coordination with the open/close operation of the shutter for blocking the projection light. This makes it possible to perform switching of the image to be projected quickly and switch a presentation smoothly without the possibility of the screen during the operation being viewed by the viewer.

Moreover, according to this application example, if it is detected that the other image signal is input when the shutter is closed to bring a state to a light blocking state, it is possible to select switching to the currently selected image signal or the other image signal if the shutter is opened again to bring a state to a projection state. This makes it possible to select an intended image signal easily and perform input switching operation in switching a presentation, for example.

Furthermore, according to this application example, the operator can find that the other image signal is input in a light blocking state in which the shutter is closed. This makes it possible to prevent the shutter from being opened and projection from being performed in a state in which an image signal is still not input when a presentation is switched.

In addition, according to this application example, since the image signal input selection order associated with the open/close operation of the shutter is stored, it is possible to perform light blocking operation and image signal input switching operation only by opening and closing the shutter. This makes it possible to perform input switching operation before and after a light blocking state with simple operation. Moreover, it is possible to remove the input switching key from the operation panel of the main body.

Furthermore, according to this application example, is possible to select an operation to block the projection light while holding the selected image signal and an operation to switch the image signal in coordination with the opening and closing of the shutter based on the difference in the shutter moving operation. This makes it possible to perform light blocking operation by the shutter according to the user's intended use.

According to another application example, there is provided a method for projecting an image by using a projector including a selecting section selecting any one of a plurality of input image signals, a projecting section projecting an image according to the image signal selected by the selecting section, and a shutter blocking a projection light from the projecting section, the method including: selecting any one of the plurality of image signals; projecting an image according to the selected image signal; detecting the position of the shutter; and, if an image signal other than the image signal selected in the image input selection step is input, selecting the other image signal according to the detected position of the shutter.

According to the image projection method of this application example, switching operation to switch the image signal to the next image signal is performed if a state is brought to a light blocking state by closing the shutter during a presentation. Thus, if the shutter is opened again, the state enters a state in which an image of the next image signal is projected. That is, the image signal switching operation is performed in coordination with the open/close operation of the shutter for blocking the projection light. This makes it possible to perform switching of the image to be projected quickly and switch a presentation smoothly without the possibility of the screen during the operation being viewed by the viewer.

### BRIEF DESCRIPTION OF THE DRAWINGS

The invention will be described with reference to the accompanying drawings, wherein like numbers reference like elements.

FIG. 1 is a perspective view of a projector.

FIGS. 2A and 2B are partial plan views, FIG. 2A being a partial view of an area around a slit in a top face of a housing 2, and FIG. 2B being a partial view of an area around an input operating section on the top face of the housing.

FIGS. 3A to 3C are front views of the projector and show the open and closed states of a shutter.

FIG. 4 is a block diagram showing the circuit configuration of the projector.

FIG. 5 is a flowchart showing the operation of the projector of a first embodiment.

FIG. 6 is a flowchart showing the input selection operation of a projector of Modified Example 1.

FIGS. 7A to 7C show the operation of Modified Example 1.

FIG. 8 is a flowchart showing the operation of a projector of Modified Example 4.

### DESCRIPTION OF EXEMPLARY EMBODIMENTS

Hereinafter, an embodiment of the invention will be described based on the accompanying drawings. It should be understood that the embodiment described below is not meant to limit the scope of the invention claimed in the appended claims in any way, and all combinations of the features described in the embodiment are not always necessary for means for solving the problems.

### First Embodiment

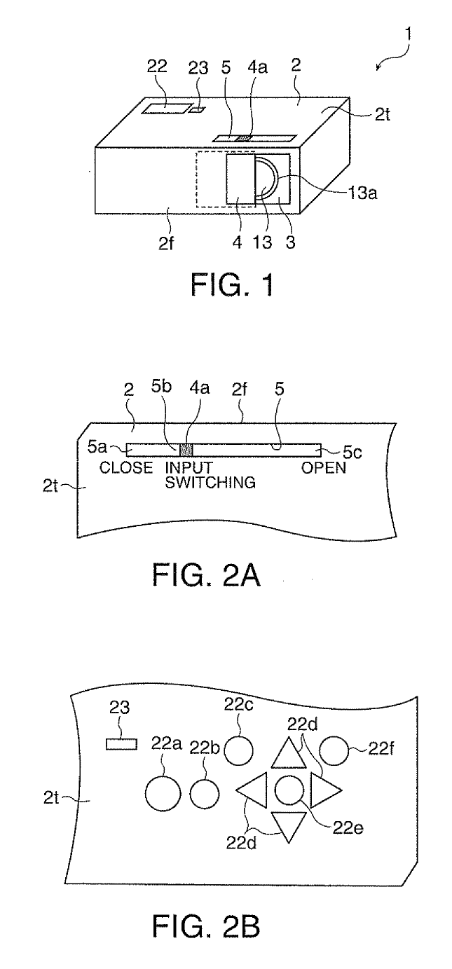

FIG. 1 is a perspective view of a projector according to this embodiment.

As shown in FIG. 1, a projector 1 is so structured that an apparatus main body is covered with a housing 2. A front face 2f of the housing 2 has an opening 3. On a top face 2t of the housing 2, an input operating section having a plurality of operation keys on which input operation is performed by the user is provided. Near the input operating section 22, an LED (light emitting diode) notifying section 23 for notifying the operating state of the projector 1 is provided.

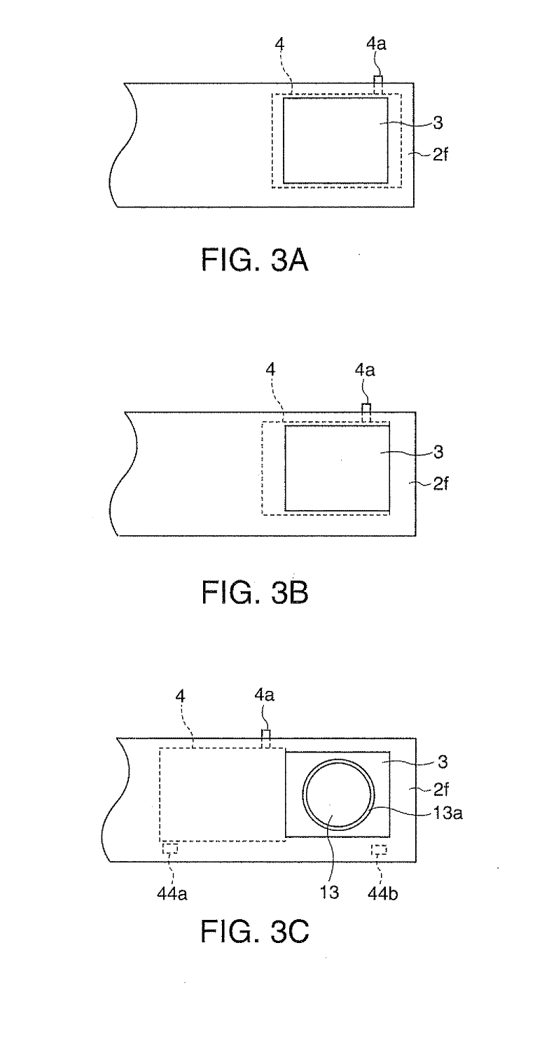

The opening 3 is formed in the front face 2f of the housing 2, and a projection lens 13 projecting an image light toward the front is provided behind the opening 3. A shutter 4 serving as a covering member is provided on the opening 3 so as to be openable and closable. By closing the opening 3 with the shutter 4, it is possible to protect the projection lens 13 and block the projection light. The shutter 4 is a plate-shaped member which is formed of synthetic resin and has a virtually rectangular shape. In one corner part of the shutter 4, an operation knob 4a for performing opening and closing operation is integrally formed (see FIGS. 3A to 3C). The operation knob 4a is exposed from a slit 5 formed in the top face 2t of the housing 2. By sliding the operation knob 4a along the slit 5 from side to side, it is possible to open and close the shutter 4. Moreover, the operation knob 4a projects to a level higher than the level of the top face 2t of the housing 2, making it easy to slide the operation knob 4a. The shutter 4 may move by sliding the operation knob 4a by hand, or may move automatically by user's operations (pushing a button, for example).

FIGS. 2A and 2B are partial plan views of the projector 1. FIG. 2A shows a partial area around the slit 5 in the top face 2t of the housing 2, and FIG. 2B shows a partial area around the input operating section 22 on the top face 2t of the housing 2. FIGS. 3A to 3C are partial front views of the projector 1 and show the open and closed states of the shutter 4.

As shown in FIG. 2A, the slit 5 is formed so as to be substantially parallel to the front face 2f of the housing 2, and the shutter 4 can move between a position in which the operation knob 4a makes contact with a left end (an end on the left side with respect to the front (a direction in which the light is emitted)) 5a of the slit and a position in which the operation knob 4a makes contact with a right end (an end on the right side with respect to the front (a direction in which the light is emitted)) 5c of the slit 5.

When the operation knob 4a is slid and moved to the left end 5a of the slit 5, the shutter 4 closes the opening 3 as shown in FIG. 3A and covers the projection lens 13, thereby protecting the light exit surface of the projection lens 13 and blocking the light. Then, if the operation knob 4a is slid and moved to the right end 5c of the slit 5, the shutter 4 moves from the front (a direction in which the light is emitted) of the projection lens 13 as shown in FIG. 3C and opens the opening 3. As a result, the projection lens 13 is exposed from the opening 3, making it possible to project the image light. Moreover, the slit 5 has a position 5b between the left end 5a and the right end 5c. As shown in FIG. 3B, by sliding the operation knob 4a and moving the shutter 4 from the right end 5c to the position 5b of the slit 5, the shutter 4 can close the opening 3 and cover the projection lens 13 without moving to the left end 5a, thereby blocking the image light. Incidentally, hereinafter, the position of the shutter 4 if the operation knob 4a is moved to the left end 5a of the slit 5 is referred to as a “close position”, the position of the shutter 4 when the operation knob 4a is moved to the right end 5c of the slit 5 is referred to as an “open position”, and the position of the shutter 4 when the operation knob 4a is moved to the position 5b of the slit 5 is referred to as an “input switching position”. That is, the shutter 4 can slide in a lateral direction along the front face 2f by an unillustrated sliding mechanism, and can selectively move between an open position in which the shutter 4 does not block the projection light by exposing a projection-side part 13a of the projection lens 13 outside the projector 1 and a close position in which the shutter 4 blocks the projection light by covering the projection-side part 13a of the projection lens 13 placed in the opening 13 with the shutter 4.

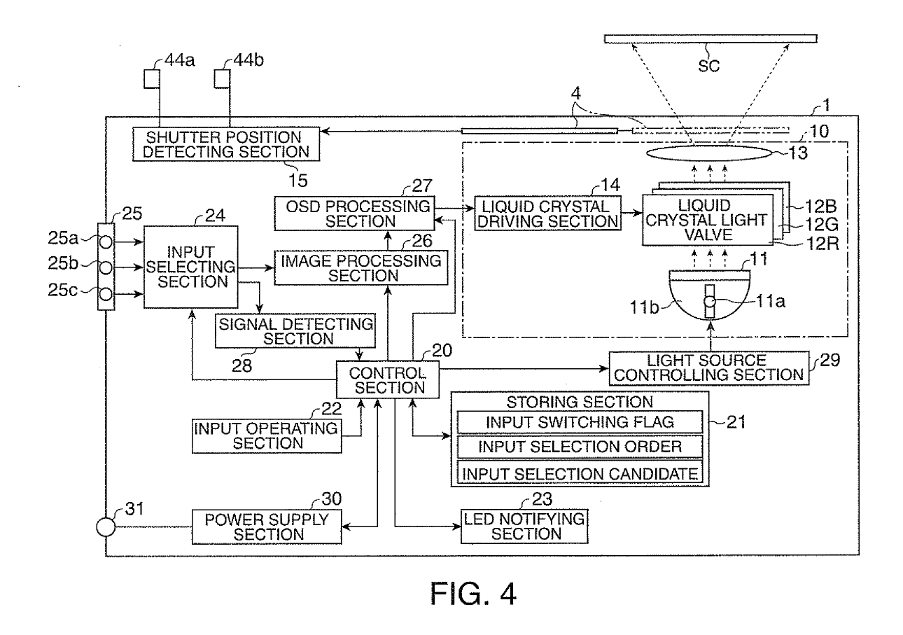

In the front face 2f, a shutter position detecting section 15 (see FIG. 4) serving as a position detecting section is provided. As shown in FIG. 3C, a pair of sensors 44a and 44b serving as a first position detecting section is embedded, and the shutter position detecting section 15 can determine whether the shutter 4 is in an open position and in an open state or the shutter 4 is in a close position and in a closed state based on the detection signals of the sensors 44a and 44b.

Incidentally, though not shown in the drawings, an input switching position detector sensor which detects that the shutter 4 is in an input switching position between an open position and a close position and serves as a second position detecting section may be provided in the shutter position detecting section 15. This input switching position detector sensor makes it also possible to determine that the shutter 4 is in an input switching position between an open position and a close position.

FIG. 4 is a block diagram showing the circuit configuration of the projector 1.

As shown in FIG. 4, the projector 1 includes an image projecting section 10 serving as a projecting section, a shutter position detecting section 15, a control section 20, a storing section 21, an input operating section 22, an LED notifying section 23, an input selecting section 24 serving as an image input selecting section, an image input terminal 25, an image processing section 26, an OSD processing section 27, a signal detecting section 28, a light source controlling section 29, a power supply section 30, a power supply terminal 31, and the like, and these component elements are housed in the housing 2 (FIGS. 1 and 2).

The image projecting section 10 includes a light source 11, three liquid crystal light valves 12R, 12G, and 12E serving as a light modulation apparatus, the projection lens 13 serving as a projection system, a liquid crystal driving section 14, and the like. The image projecting section 10 corresponds to a display section and displays an image on a screen SC or the like by forming image lights by modulating the light emitted from the light source 11 by means of the liquid crystal light valves 12R, 12G, and 12B, combining the image lights by an unillustrated combining prism, and projecting the image light thus obtained from the projection lens 13 formed of a plurality of lenses.

The light source 11 includes a discharge light source lamp 11a formed of an ultra-high pressure mercury lamp, a metal halide lamp, or the like and a reflector 11b which reflects the light emitted from the light source lamp 11a toward the liquid crystal light valves 12R, 12G, and 12B. The light emitted from the light source 11 is converted into a light having a virtually uniform luminance distribution by an unillustrated optical integration system and is separated by an unillustrated color separation system into color light components of red (R), green (G), and blue (B) which are three primary colors of light, and the color light components of red (R), green (G), and blue (B) enter the liquid crystal light valves 12R, 12G, and 12B, respectively.

The liquid crystal light valves 12R, 12G, and 12B are each formed of a liquid crystal panel or the like formed of a pair of transparent substrates between which a liquid crystal is encapsulated. In the liquid crystal light valves 12R, 12G, and 12B, a plurality of pixels (not shown) arranged in a matrix are formed, and it is possible to apply a drive voltage to the liquid crystal for each pixel. When the liquid crystal driving section 14 applies a drive voltage according to the input image information to each pixel, each pixel is set at a light transmittance according to the image information. Therefore, the light emitted from the light source 11 is modulated as a result of passing through the liquid crystal light valves 12R, 12G, and 12B, and the image light according to the image information is formed for each color light. The formed image lights of different colors are combined in each pixel by an unillustrated light combining system and become a color image light. Then, the color image light is enlarged and projected onto the screen SC or the like by the projection lens 13. In the embodiment described above, the projector 1 which performs projection by using the light source lamp 11a as the light source 11 is taken up as an example. However, the invention can also be applied to a projector which performs projection by using an LED light source or a laser light source as a light source. Incidentally, in the embodiment described above, an example in which the image projecting section 10 adopts a transmissive liquid crystal display-type projection system using the light source 11 and the three liquid crystal light valves 12R, 12G, and 12B serving as a light modulation apparatus is described. However, regarding the display principles, other display methods such as a reflective liquid crystal display method or a micromirror device method (a light switch display method) may be adopted.

The control section 20 includes a CPU (central processing unit) and RAM (random access memory) etc. which is used for temporarily storing various data and the like and performs centralized control of the operation of the projector 1 by operating according to a control program product (not shown) stored in the storing section 21. That is, the control section 20 functions as

The storing section 21 is formed of rewritable nonvolatile memory such as flash memory or FeRAM (Ferroelectric RAM). The storing section 21 stores a control program product for controlling the operation of the projector 1 and various setting data etc. which defines the operation conditions and the like of the projector 1. In this embodiment, as the setting data, an input switching flag for performing input switching of the image input terminal 25 according to the position of the shutter 4 and the detection result of the signal detecting section 28, an input selection order in which the image input terminal 25 is switched, an input selection candidate to which the image input terminal 25 is switched, and the like are stored.

The input operating section 22 accepts an input operation from the user and includes a plurality of operation keys used by the user for giving various types of instructions to the projector 1. As shown in FIG. 2B, the operation keys of the input operating section 22 include a power supply key 22a for alternately switching on/off of the power supply, an input switching key 22b for switching between a plurality of image input terminals 25, a menu key 22c for displaying a setting menu for making various types of settings in such a way that the setting menu is displayed on the screen, four direction keys 22d by which the user selects a setting item from the menu, an Enter key 22e, an escape key 22f, and other keys. If the user operates various types of operation keys of the input operating section 22, the input operating section 22 outputs an operation signal according to the operation performed by the user to the control section 20. Moreover, the operation keys may be operated via a remote controller (not shown). It is preferable that the remote controller be, for example, a wireless communication terminal which the user can carry around, and operation buttons having the functions similar to those of the above-described various types of operation keys be placed on the front surface of the remote controller.

As described above, the image input terminal 25 includes a plurality of image input terminals 25a, 25b, and 25c. To each image input terminal 25, image information is input from an external image output apparatus such as a video reproduction apparatus or a personal computer via an unillustrated cable. The image information input to each image input terminal 25 is supplied to the input selecting section 24 which is an image input selecting section.

The input selecting section 24 which is an image input selecting section outputs the image information input to one image input terminal of the plurality of image input terminals 25 (25a, 25b, and 25c), the image input terminal selected based on the instruction from the control section 20, to the image processing section 26 and the signal detecting section 28. If the user specifies intended one image input terminal by operating the input switching key 22b of the input operating section 22, the control section 20 gives an instruction to the input selecting section 24 so that the image information input to the one image input terminal is output to the image processing section 26.

The signal detecting section 28 notifies the control section 20 of the detection result as to whether or not a valid image signal is input from the image input terminal 25 selected by the input selecting section 24.

The LED notifying section 23 is an indicator provided with an LED (light emitting diode) and notifies the user of the operation state (on/off of the power supply, the occurrence of an abnormality, the detection of a signal, and the like) of the projector 1 by switching the display state thereof based on the instruction from the control section 20. Incidentally, the LED notifying section 23 can indicate a large number of operation states by appropriately switching the display states thereof, that is, lighting, blinking, light shutoff, emission color, and the like.

The image processing section 26 converts the image information input from the input selecting section 24 into image information indicating the gradation of each pixel of the liquid crystal light valves 12R, 12G, and 12B. Here, the converted image information differs according to the color lights of R, G, and B, and is formed of a plurality of pixel values corresponding to all the pixels of the liquid crystal light valves 12R, 12G, and 12B. The pixel value defines the light transmittance of a corresponding pixel, and the intensity (gradation) of the light which passes through each pixel and is then emitted is defined by the pixel value.

When the liquid crystal driving section 14 drives the liquid crystal light valves 12R, 12G, and 12B according to the image information input from the OSD processing section 27, the liquid crystal light valves 12R, 12G, and 12B form an image according to the image information, and this image is projected from the projection lens 13.

Based on the instruction from the control section 20, the OSD processing section 27 performs processing for superimposing an OSD (on-screen display) image such as a menu image or a message image on the input image. The OSD processing section 27 includes unillustrated OSD memory and stores image data representing graphics, fonts, etc. used for forming the OSD image. When the control section 20 gives an instruction to superimpose the OSD image, the OSD processing section 27 reads necessary image data from the OSD memory and generates OSD image information for forming the designated OSD image. Then, the OSD processing section 27 combines the OSD image information with the image information input from the image processing section 26 so that the OSD image is superimposed on the input image in a predetermined position. The image information with which the OSD image information is combined is output to the liquid crystal driving section 14. Incidentally, when the control section 20 does not give an instruction to superimpose the OSD image, the OSD processing section 27 outputs the image information input from the image processing section 26 to the liquid crystal driving section 14 as it is.

A power supply such as an AC input of 100 V is supplied to the power supply section 30 from the outside via the power supply terminal 31. The power supply section 30 converts the power supply (AC power supply) into a DC power supply of a predetermined voltage and supplies electric power to individual sections, such as the light source controlling section 29, of the projector 1. Moreover, based on the instruction from the control section 20, the power supply section 30 can switch a state between a state (a power supply ON state) in which electric power (operating power) necessary to project an image is supplied to individual sections and a state (a standby state) in which the supply of the operating power is stopped until operation for turning on the power supply is performed.

The light source controlling section 29 controls the supply of the electric power to the light source 11 and stoppage thereof and thereby switches the light source 11 between a state in which the light source 11 is lit and a state in which the light source 11 is shut off based on the instruction from the control section 20.

The shutter position detecting section 15 which is a position detecting section of the shutter 4 detects whether the position of the shutter 4 when the shutter 4 is slid by the operation knob 4a is an open position, a close position, or an input switching position, and outputs the detection result to the control section 20.

If the shutter position detecting section 15 which is a position detecting section of the shutter 4 detects that the shutter 4 is moved from an open position to a close position or an input switching position, the control section 20 makes the image projecting section 10 stop projection and brings the state to a mute state. Moreover, at this time, the control section 20 makes the image projecting section 10 project a mute image in place of the image based on the input image signal. If the shutter position detecting section 15 detects that the shutter 4 is moved to an open position, the control section 20 ends the mute state and makes the image projecting section 10 project the image based on the input image signal.

In addition, if the signal detecting section 28 detects in a mute state that an image signal is input to any one of the image input terminals 25 other than the currently selected image input terminal 25, the control section 20 gives an instruction to the input selecting section 24 and thereby performs switching to the other image input terminal 25 to which the image signal is input. In other words, if an image signal other than the image signal which is selected by the input selecting section 24 is input, the input selecting section 24 selects the other image signal according to the position of the shutter 4 detected by the shutter position detecting section 15.

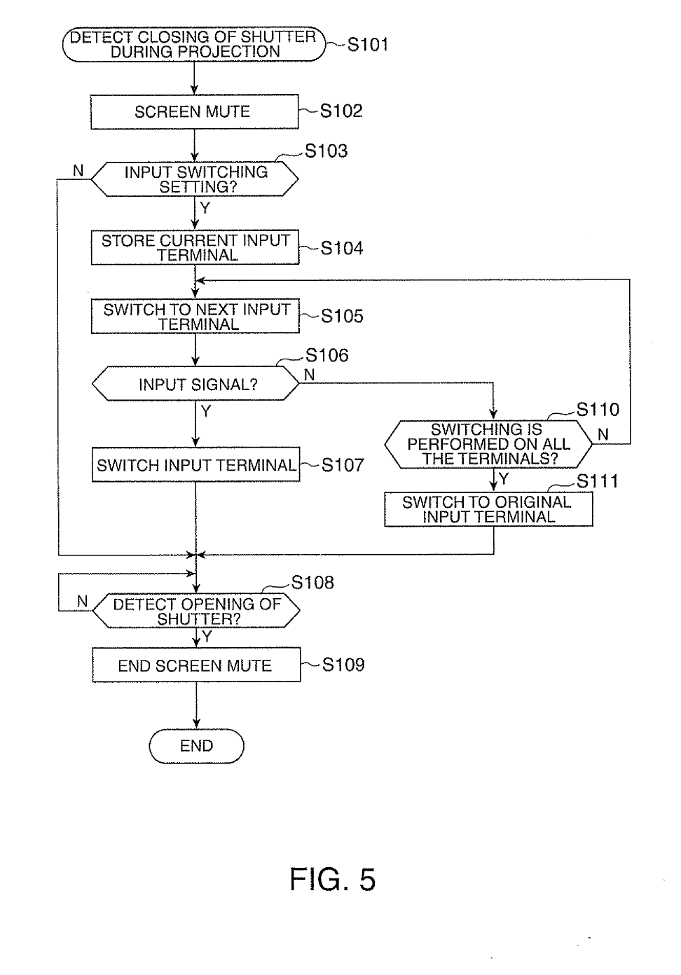

Next, the operation of the projector 1 of this embodiment will be described by using a flowchart of FIG. 5.

FIG. 5 is an example of an operation flowchart when the shutter 4 of the projector 1 which is performing projection operation is opened/closed.

As shown in FIG. 5, first, when it is detected that the shutter 4 is slid while the projector 1 is performing projection operation and is moved from an open position to a close position, the shutter position detecting section 15 notifies the control section 20 of the movement of the shutter 4 (step S101). Then, the control section 20 makes the image projecting section 10 stop projection and brings a state to a mute state (step S102).

Next, the control section 20 refers to the input switching flag stored in the storing section 21 and determines whether or not the input switching operation is valid (step S103). If the input switching operation is valid, the control section 20 proceeds to step S104; if the input switching operation is invalid, the control section 20 proceeds to step S108.

In step S104, the control section 20 stores the information indicating the currently selected image input terminal 25 in the storing section 21 and proceeds to step S105.

In step S105, the control section 20 gives an instruction to the input selecting section 24 and thereby switches the image input terminal 25 to the next image input terminal 25. Next, the control section 20 determines whether or not an image signal is input to the selected image input terminal 25 based on the detection result of the signal detecting section 28 (step S106). If the image signal is input, the control section 20 proceeds to step S107. If the image signal is not input to the selected image input terminal 25, the control section 20 checks whether or not the selected image input terminal 25 is the last image input terminal, that is, switching is performed on all the image input terminals (step S110). If the selected image input terminal 25 is the, last image input terminal, the control section 20 proceeds to step S111. If the selected image input terminal 25 is not the last image input terminal, the control section 20 goes back to step S105.

In step S107, the control section 20 gives an instruction to the input selecting section 24 and thereby performs switching to the image input terminal 25 detected in step S106 as an image input terminal 25 to which the image signal is input, and proceeds to step S108.

In step S111, the control section 20 gives an instruction to the input selecting section 24 and thereby performs switching to the initially selected image input terminal 25 based on the information stored in the storing section 21 in step S104, and proceeds to step S108.

In step S108, if the shutter position detecting section 15 detects that the shutter 4 is moved to an open position, the control section 20 proceeds to step S109. If the shutter 4 is not moved to an open position, the control section 20 repeats step S108.

In step S109, the control section 20 ends the mute state, resumes the projection operation of the image projecting section 10, and makes the image projecting section 10 project the image signal input to the currently selected image input terminal 25. This is the end of the operation flow.

As described above, according to the projector 1 of this embodiment, if the shutter 4 is moved from an open position to a close position, the projector 1 brings a state to a mute state and performs input switching operation after searching for an image input terminal 25 other than the currently selected image input terminal 25, the image input terminal 25 to which the image signal is input. That is, the input switching operation is performed in coordination with the open/close operation of the shutter 4 for blocking the projection light and bringing a state to a mute state. This makes it possible to perform switching of the image input terminal 25 which performs projection quickly and switch a presentation smoothly without the possibility of the screen during the operation being viewed by the viewer.

### Modified Example 1

Moreover, the embodiment described above may be modified as follows.

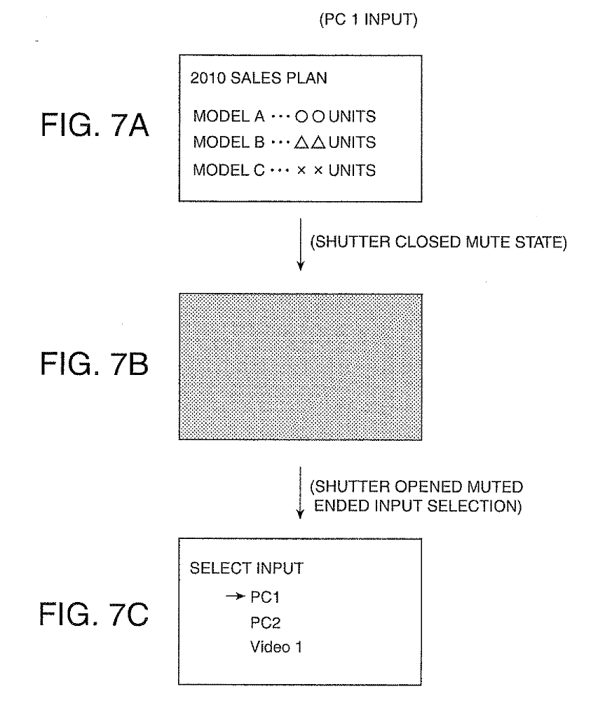

In the embodiment described above, the input switching operation is performed to switch to an image input terminal 25 detected as an image input terminal 25 to which the image signal is input, the image input terminal 25 other than the currently selected image input terminal 25, in the mute state. However, all the image input terminals 25 may be checked in the mute state, the information indicating a plurality of image input terminals 25 to which the image signal is input may be stored, a selection screen for selecting an image input terminal 25 may be displayed when the mute state is ended, and a selection may be made by operating the direction keys 22d and the Enter key 22e of the input operating section 22. FIGS. 7A to 7C show the operation screen displayed at this time.

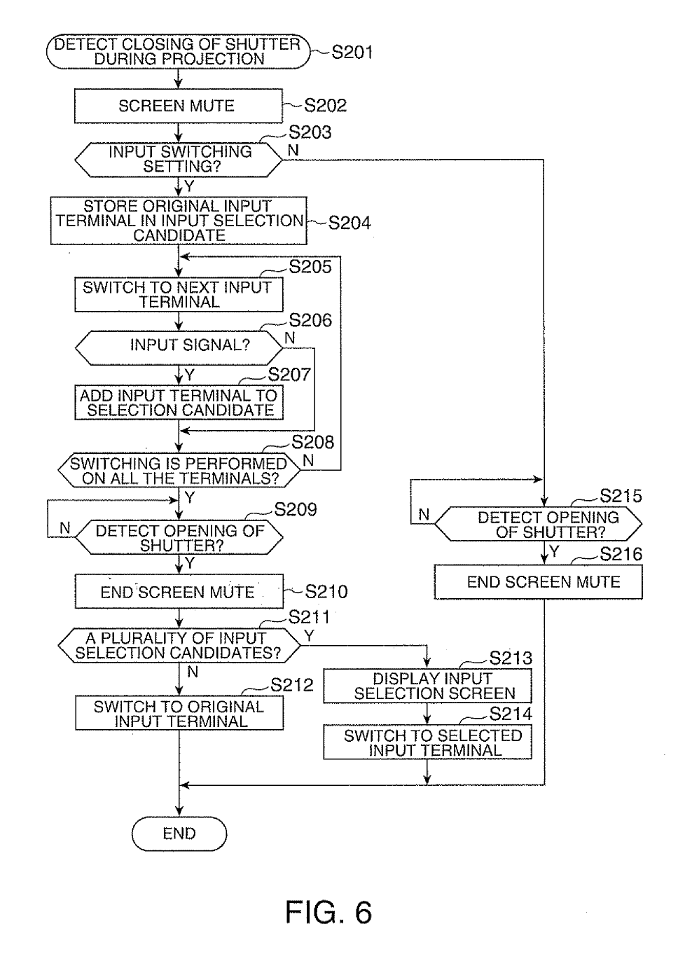

The operation of this modified example will be described by using a flowchart of FIG. 6.

As shown in FIG. 6, first, when it is detected that the shutter 4 is slid while the projector 1 is performing projection operation and is moved from an open position to a close position, the shutter position detecting section 15 notifies the control section 20 of the movement of the shutter 4 (step S201). Then, the control section 20 makes the image projecting section 10 stop projection and brings a state to a mute state (step S202).

Next, the control section 20 refers to the input switching flag stored in the storing section 21 and determines whether or not the input switching operation is valid (step S203). If the input switching operation is valid, the control section 20 proceeds to step S204; if the input switching operation is invalid, the control section 20 proceeds to step S215.

In step S204, the control section 20 stores the information indicating the currently selected image input terminal 25 in the input selection candidate of the storing section 21 and proceeds to step S205.

In step S205, the control section 205 gives an instruction to the input selecting section 24 and thereby switches the image input terminal 25 to the next image input terminal 25. Next, the control section 20 determines whether or not the input of an image signal to the selected image input terminal 25 is detected based on the detection result of the signal detecting section 28 (step S206). If the image signal is input, the control section 20 stores the information indicating the image input terminal 25 detected as an image input terminal 25 to which the image signal is input in the input selection candidate of the storing section 21 (step S207), and proceeds to step S208. If the image signal is not input to the selected image input terminal 25, the control section 20 proceeds to step S208.

In step S208, the control section 20 checks whether or not switching is performed on all the image input terminals 25. If switching is performed on all the image input terminals 25, the control section 20 proceeds to step S209; if switching is not performed on all the image input terminals 25, the control section 20 goes back to step S205.

In step S209, the control section 20 checks the detection result of the shutter position detecting section 15. If the shutter position detecting section 15 detects that the shutter 4 is moved to an open position, the control section 20 proceeds to step S210; if the shutter 4 is not moved to an open position, the control section 20 repeats step S209.

In step S210, the control section 20 ends the mute state, resumes the projection operation of the image projecting section 10, and checks whether or not two or more image input terminals 25 are registered by referring to the input selection candidate stored in the storing section 21 (step S211). If two or more image input terminals 25 are registered (step S211: Y), the control section 20 makes the image projecting section 10 project a selection screen for selecting an image input terminal, the selection screen shown in FIG. 7C (step S213), and proceeds to step S214. If only one image input terminal is registered in the input terminal candidate list (the input selection candidate), that is, if only the original image input terminal is registered (step S211: N), the control section 20 proceeds to step S212.

In step S214, the control section 20 gives an instruction to the input selecting section 24 and thereby performs switching to the selected image input terminal based on the operation by which the image input terminal is selected, the operation which is input to the input operating section 22.

In step S212, the control section 20 gives an instruction to the input selecting section 24 and thereby performs switching to the original image input terminal 25 based on the information stored in the input selection candidate of the storing section 21.

In step S215, the control section 20 checks the detection result of the shutter position detecting section 15. If the shutter position detecting section 15 detects that the shutter 4 is moved to an open position, the control section 20 proceeds to step S216; if the shutter 4 is not moved to an open position, the control section 20 repeats step S215.

In step S216, the control section 20 ends the mute state, resumes the projection operation of the image projecting section 10, and makes the image projecting section 10 project the image signal input to the currently selected image input terminal 25. This is the end of the operation flow.

As described above, in this modified example, if a state is changed from the mute state to the image projection state by opening the shutter 4 again, it is possible to select switching to the currently selected image input terminal 25 or the other image input terminal to which the image signal is input. This makes it possible to select easily an intended input terminal to which a signal is input and perform input switching operation in switching a presentation, for example.

### Modified Example 2

In the embodiment described above, when it is detected in the mute state that an image signal is input to an image input terminal 25 other than the currently selected image input terminal 25, notification of the detection result may be provided by the LED notifying section 23. With this configuration, the operator can find that an image signal is input to the other image input terminal 25 in the mute state in which the shutter is closed. This makes it possible to prevent the shutter 4 from being opened and projection from being performed in a state in which an image signal is still not input when switching of a presentation is performed.

### Modified Example 3

In the embodiment described above, the input selection order of the image input terminal 25 when the shutter 4 is closed may be stored in the storing section 21. At this time, by switching an input irrespective of the presence or absence of the detection of an image input signal, as the shutter 4 is closed, a state becomes the same state as the state in which the input switching key 22b of the input operating section 22 is operated. With this configuration, it is possible to perform input switching operation before and after the mute state with simple operation. Furthermore, it is possible to remove the input switching key 22b from the input operating section 22 and thereby provide a projector with a simple configuration.

### Modified Example 4

In the embodiment described above, the shutter 4 may be moved to an input switching position from the image projection state without moving the shutter 4 to a close position, and, when the shutter 4 is then moved to an open position, the image input terminal 25 may be switched to the other image input terminal 25; when the shutter 4 is then moved to an open position after the shutter 4 is moved to a close position, input switching operation of the image input terminal 25 may not be performed.

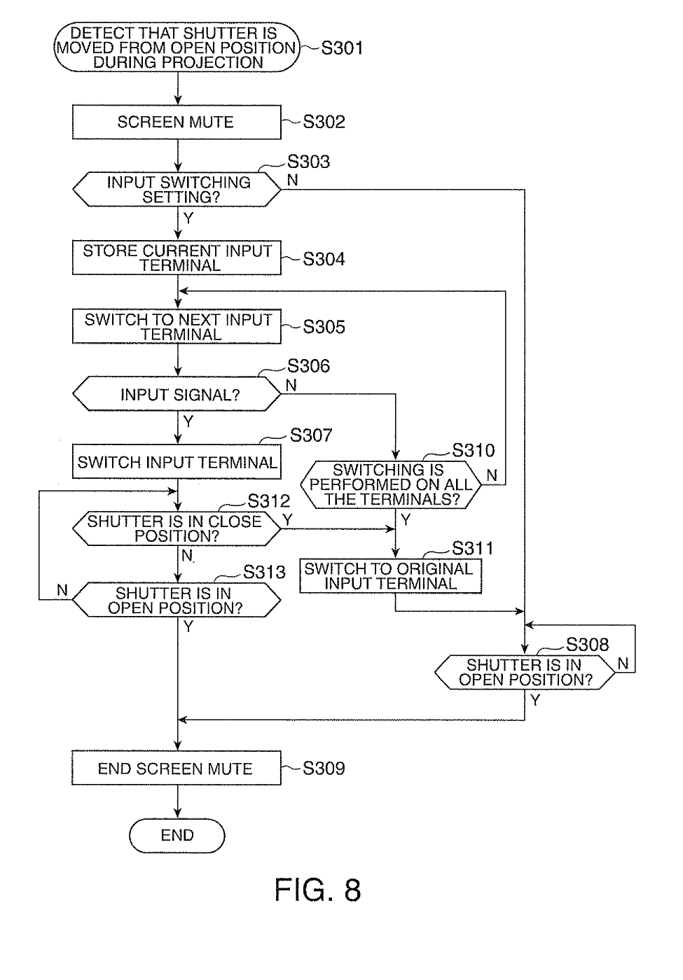

The operation of this modified example will be described by using a flowchart of FIG. 8.

As shown in FIG. 8, first, when it is detected that the shutter 4 is slid while the projector 1 is performing projection operation and is moved from an open position to an input switching position or a close position, the shutter position detecting section 15 notifies the control section 20 of the movement of the shutter 4 (step 8301). Then, the control section 20 makes the image projecting section 10 stop projection and brings a state to a mute state (step S302).

Next, the control section 20 refers to the input switching flag stored in the storing section 21 and determines whether or not the input switching operation is valid (step S303). If the input switching operation is valid, the control section 20 proceeds to step S304; if the input switching operation is invalid, the control section 20 proceeds to step S308.

In step S304, the control section 20 stores the information indicating the currently selected image input terminal 25 in the storing section 21 and proceeds to step S305.

In step S305, the control section 20 gives an instruction to the input selecting section 24 and thereby switches the image input terminal 25 to the next image input terminal 25. Next, the control section 20 determines whether or not an image signal is input to the selected image input terminal 25 based on the detection result of the signal detecting section 28 (step S306). If the image signal is input to the selected image input terminal 25, the control section 20 proceeds to step S307. If the image signal is not input to the selected image input terminal 25, the control section 20 checks whether or not the selected image input terminal 25 is the last image input terminal (step S310). If the selected image input terminal 25 is the last image input terminal (step S310: Y), the control section 20 proceeds to step S311. If the selected image input terminal 25 is not the last image input terminal (step S310: N), the control section 20 goes back to step S305.

In step S307, the control section 20 gives an instruction to the input selecting section 24 and thereby performs switching to the image input terminal 25 detected in step S306 as an image input terminal 25 to which the image signal is input, and proceeds to step S312.

In step S311, the control section 20 gives an instruction to the input selecting section 24 and thereby performs switching to the image input terminal 25 stored in the storing section 21 in step S304, and proceeds to step S308.

In step 3312, the control section 20 checks the detection result of the shutter position detecting section 15. If the shutter position detecting section 15 detects that the shutter 4 is in a close position (step S312: Y), the control section 20 proceeds to step S311. If the shutter position detecting section 15 detects that the shutter 4 is not in a close position (step S312: N), the control section 20 proceeds to step S313.

In step S313, the control section 20 checks the detection result of the shutter position detecting section 15. If the shutter position detecting section 15 detects that the shutter 4 is in an open position (step S313: Y), the control section 20 proceeds to step S309. If the shutter position detecting section 15 detects that the shutter 4 is not in a close position, that is, the shutter 4 is neither in a close position nor an open position (step S313: N), the control section 20 goes back to step S312.

In step S308, the control section 20 checks the detection result of the shutter position detecting section 15. If the shutter position detecting section 15 detects that the shutter 4 is moved to an open position, the control section 20 proceeds to step S309. If the shutter 4 is not moved to an open position, the control section 20 repeats step S308.

In step S309, the control section 20 ends the mute state, resumes the projection operation of the image projecting section 10, and makes the image projecting section 10 project the image signal input to the currently selected image input terminal 25. This is the end of the operation flow.

In the above description, the protrusion of the projection-side part 13a of the projection lens 13 is not large. However, for example, if the projection-side part 13a protrudes considerably, it is not easy to cover the projection-side part 13a with the shutter 4. In this case, the shutter 4 can be provided on the back (a side opposite to a direction in which the light is emitted) or the inside of the projection lens 13, that is, between the projection lens 13 and the combining prism or between a plurality of lenses of the projection lens 13.

As described above, according to this modified example, only by opening and closing the shutter 4, it is possible to select a case in which only mute operation is performed and a case in which both mute operation and input switching operation are performed. This makes it possible to select easily mute operation performed by the shutter 4, the mute operation in accordance with the user's purpose.

Moreover, in this embodiment, the input of an image signal to the image input terminal 25 is detected. However, a configuration in which it is detected whether or not a recording medium (USB memory or an SD memory card) is inserted may be adopted. In such a case, since it is also possible to detect that the recoding medium is connected to the image input terminal 25, it is also possible to select easily, only by opening and closing the shutter 4, a case in which only mute operation is performed and a case in which both mute operation and input switching operation to perform switching to the recording medium or the like are performed.

What is claimed is:

1. A projector comprising:
a selecting section selecting any one of a plurality of image signals input to the projector;
a projecting section projecting an image according to the image signal selected by the selecting section;
a shutter blocking a projection light from the projecting section; and
a position detecting section detecting the position of the shutter,
wherein
if an image signal other than the image signal selected by the selecting section is input, the selecting section selects the other image signal according to the position of the shutter detected by the position detecting section.

2. The projector according to claim 1, wherein
if the shutter is moved from an open position to a close position while the other image signal is input, the selecting section selects the other image signal if the shutter is moved from a close position to an open position.

3. The projector according to claim 1, further comprising:
an input operating section performing switching operation of the image signal,
wherein
if the shutter is moved from an open position to a close position while the other image signal is input, the selecting section selects the image signal selected based on the switching operation performed by the input operating section if the shutter is moved from a close position to an open position.

4. The projector according to claim 1, further comprising:
a notifying section providing a notification of the input of the other image signal if the shutter is moved from an open position to a close position.

5. The projector according to claim 1, further comprising:
a storing section storing an input selection order in which the plurality of image signals are selected,
wherein
the selecting section selects any one of the plurality of image signals according to the input selection order stored in the storing section if the shutter is moved from an open position to a close position.

6. The projector according to claim 1, wherein
the position detecting section includes a first position detecting section detecting that the shutter is in an open position or a close position and a second position detecting section detecting that the shutter is in an input switching position between an open position and a close position, and
if the shutter is moved to an open position without moving to a close position after moving from an open position to an input switching position, the selecting section selects the other image signal.

7. A method for projecting an image by using a projector including a selecting section selecting any one of a plurality of input image signals, a projecting section projecting an image according to the image signal selected by the selecting section, and a shutter blocking a projection light from the projecting section, the method comprising:
selecting any one of the plurality of image signals;
projecting an image according to the selected image signal;
detecting the position of the shutter; and
if an image signal other than the selected image signal is input, selecting the other image signal according to the detected position of the shutter.
